(19) United States
(12) Patent Application Publication
(10) Pub. No.: US 2011/0072371 A1
(43) Pub. Date: Mar. 24, 2011

(54) APPLICATION PROGRAMMING INTERFACE FOR USER INTERFACE CREATION

(75) Inventors: Todd Segal, Seattle, WA (US); Jeffrey Michael MacDuff, Kirkland, WA (US); Michael Matteson, Bellevue, WA (US); Ritwik Tewari, Woodinville, WA (US); Brett Robinson, Seattle, WA (US); Prakash Ajay Kumar Suri, Sammamish, WA (US); David Shoemaker, Monroe, WA (US); Xiangying Ma, Issaquah, WA (US)

(73) Assignee: MICROSOFT CORPORATION, Redmond, WA (US)

(21) Appl. No.: 12/562,401

(22) Filed: Sep. 18, 2009

(51) Int. Cl. G06F 3/048

(52) U.S. Cl. 715/763; 715/760

(57) ABSTRACT

Various embodiments related to an application programming interface for user interface creation are disclosed herein. For example, one disclosed embodiment provides an application programming interface, embodied on one or more data-holding subsystems, comprising user interface creation services for intermediately defining a user interface including one or more user interface elements as declarative extensible markup language data. The application programming interface further comprises compiler services for providing aspects of the declarative extensible markup language data to one or more compilers for compilation into two or more different machine code implementations, where each machine code implementation is natively executable without a virtual machine by a different hardware platform to present the user interface intermediately defined as declarative extensible markup language data.

### BACKGROUND

Traditional user interfaces are ever-improving to provide a more effective user experience. Oftentimes significant system resources (storage, memory, processing, etc.) are utilized in order to provide the look and feel of these more advanced user interfaces. Therefore, devices with resource limitations such as handheld computing devices, GPSs, media players, and the like, may face constraints in implementing rich user experiences. Furthermore, the vast number of different devices poses challenges in creating consistent interfaces for all such devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various embodiments related to an application programming interface for user interface creation are disclosed herein. For example, one disclosed embodiment provides an application programming interface, embodied on one or more data-holding subsystems, comprising user interface creation services for intermediately defining a user interface including one or more user interface elements as declarative extensible markup language data. The application programming interface further comprises compiler services for providing aspects of the declarative extensible markup language data to one or more compilers for compilation into two or more different machine code implementations, where each machine code implementation is natively executable without a virtual machine by a different hardware platform to present the user interface intermediately defined as declarative extensible markup language data.

### BRIEF DESCRIPTION OF THE DRAWINGS

FIG. 1 schematically shows a user interface creation system according to an embodiment of the present disclosure.

FIG. 2 schematically shows an example computing system.

FIG. 3 shows a flow diagram of an example method of user interface creation.

### DETAILED DESCRIPTION

User interfaces having advanced visual and interactive features may facilitate a more effective user experience for a user, but oftentimes such interfaces may be constrained by the amount and availability of system resources. For example, user interfaces within the framework of rich internet applications (RIAs) typically have features and functionality similar to that of desktop applications, and may be executed via plug-ins, such as web browser plug-ins, or other software implementations such as virtual machines. However, such implementations may utilize significant system resources. As a result, user interfaces traditionally created for resource-constrained embedded devices such as mobile phones, handheld computing devices, personal digital assistants, GPS devices, media players, digital picture frames, etc. may lack these advanced visual and interactive features. Since it may be difficult or unfeasible for existing user interface designs and code to be utilized on resource-constrained embedded devices, more “lightweight” versions of user interfaces are typically created for embedded devices. Although these lightweight versions of rich user interfaces may be specifically coded to natively run on embedded devices, such development is oftentimes done independently of other user interface design since the vector graphic tools primarily utilized for rich user interfaces are typically not configured for coding user interfaces to run natively on embedded devices. By not being able to take advantage of these existing tools and knowledge, traditional user interface development for embedded devices may duplicate development efforts, adding additional work and time to a design and development workflow. Further, by not having a design and development toolset that is compatible with all devices, it may be difficult to maintain consistency in a look and feel of a user interface across a variety of platforms.

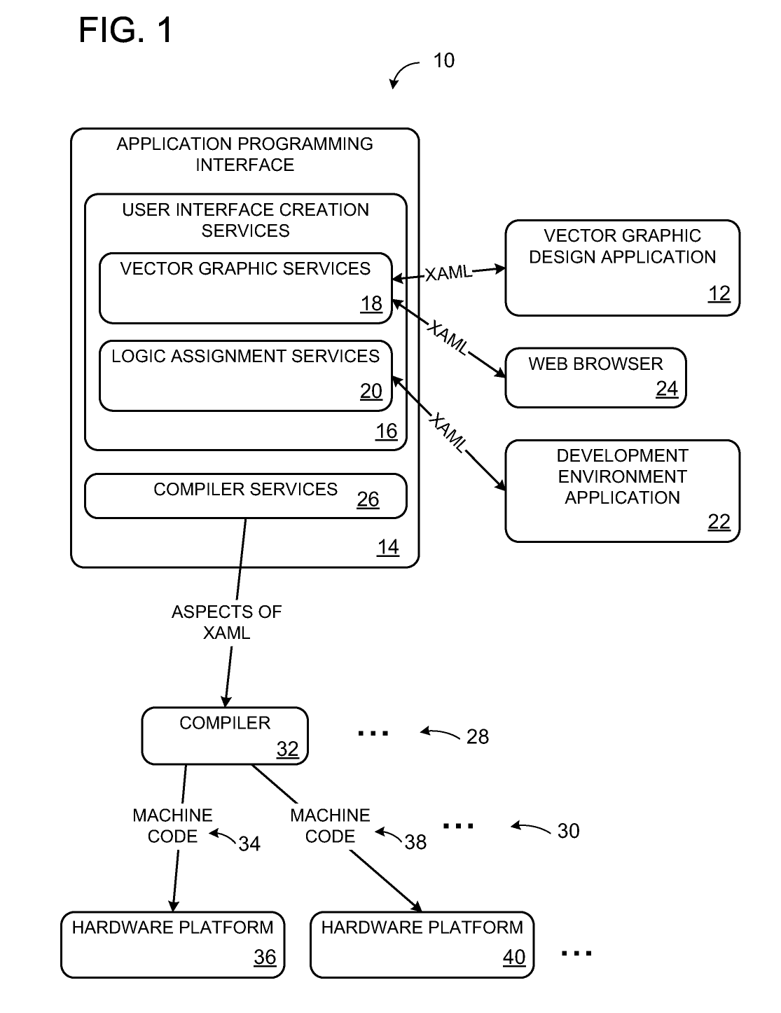

As described herein, an application programming interface (API) can be utilized for creating user interfaces for a variety of different devices, including embedded devices. In addition to dictating how an application may request services from libraries and/or operating systems, APIs may also, or alternatively, facilitate communication between applications. FIG. 1 schematically shows a user interface creation system 10 for creating a user interface. User interface creation system 10 includes a vector graphic design application 12 for visually designing the user experience. In other words, such an application may design a look and a feel of rich user interfaces, and typically is configured to output “managed code” that is executable by a virtual machine. As such, vector graphic design application 12 may traditionally be utilized when designing user interfaces for computing devices having significant system resources for executing the user interface with the help of a virtual machine. Further, since a vector graphic design application such as vector graphic design application 12 may not be capable of outputting machine code that is natively executable on an embedded device, vector graphic design application 12 traditionally may not be utilized for designing user interface experiences for embedded devices.

As an example, vector graphic design application 12 may have an interactive front-end visual editor environment for designing the look and the feel of the user interface, as opposed to a back-end code editor. In other words, vector graphic design application 12 may have a what-you-see-is-what-you-get (WYSIWYG) design environment enabling visual design that is independent of the assignment of operation/business logic. Examples of features of vector graphic design application 12 may include, but are not limited to, use of visual objects for drag-and-drop placement, use of templates, efficient visual prototyping, enabling interactivity without writing code (e.g., animations, transitions, behaviors, etc.), and the like. As a nonlimiting example, the vector graphic design application may be Microsoft® Expression Blend®.

Further, in some embodiments, vector graphic design application 12 may include a web framework core configured to integrate one or more of graphics, animations, multimedia and interactivity into a single runtime environment. For example, the web framework core may include a cross-browser, cross-platform and cross-device browser plug-in. As a nonlimiting example, such a web framework core may include Microsoft® Silverlight®. Additionally, vector graphic design application 12 may be configured to interface with existing platforms, such as a graphical subsystem for rendering user interfaces in applications. As a nonlimiting example, vector graphic design application 12 may be configured to interface with Microsoft® Windows Presentation Foundation (WPF).

User interface creation system 10 further includes an API 14 which may be embodied on one or more data-holding subsystems. Examples of data-holding subsystems include, but are not limited to, mass storage devices, removable storage devices, run-time memory, and the like. API 14 may be configured to interact with one or more applications and/or allow interaction between one or more applications, including vector graphic design application 12, for creating user interfaces that are natively executable on embedded devices. Further, API 14 may be configured to interface with such applications in any suitable manner. For example, in one embodiment, API 14 includes user interface creation services 16 for intermediately defining a user interface including one or more user interface elements as declarative extensible markup language data. As will be described in more detail hereafter, a declarative extensible markup language may be utilized for specifying user interface element definition and behavior. Further, the declarative extensible markup language data may be human and machine readable.

User interface creation services 16 may be configured to intermediately define the user interface as declarative extensible markup language data in any suitable manner. In some embodiments, user interface creation services 16 may include vector graphic services 18 configured to interface with vector graphic design application 12 so as to enable visual design of the user interface including one or more user interface elements. Further, as described above, vector graphic design application 12 may include a web framework core. Therefore vector graphic services 18 may then be further configured to provide access to this web framework core.

User interface creation services 16 may further include logic assignment services 20 for receiving from a development environment application 22, such as Microsoft® Visual Studio®, one or more operation logic assignments corresponding to the user interface that are independent of the look and the feel of the user interface. For example, the development environment may include a back-end code editor configured to assign operation logic to the user interface designed by the vector graphic design application. Examples of operation logic that may be assigned to the user interface include, but are not limited to, event handling, database manipulation, and business logic. As an example, an event may include a message sent by an object to signal the occurrence of an action. The action could be caused by a user interaction, such as a mouse click, or it could be triggered by some other program logic, such as a value exceeding or falling below a particular threshold. Thus, event handling may include specifying such actions within the user interface.

As such, vector graphic services 18 and logic assignment services 20 may be independently operable, thus separating design of the look and feel of the user interface from assignment of the operation logic of the user interface. Therefore, the design/development gap existing in traditional user interface design may be resolved in that API 14 of user interface creation system 10 allows for separation of the user experience definition from the runtime logic. As an example, designers and developers utilizing user interface creation system 10 may work in parallel when creating a user interface, thus increasing productivity. Thus, user interface creation system 10 may separate the design phase from the development phase, so designers and developers can each focus their respective tasks. In other words, designers can focus on designing the look and feel of the user interface/experience, and developers can focus on code development such as event handling, database manipulation, and other non-user interface functionality/business logic.

Further, due to this separation, the user interface intermediately defined as the declarative extensible markup language data may be subsequently modified by vector graphic design application 12 independent of development environment application 22. As an example, upon creating a user interface, a designer may subsequently make additional changes to the visual design of the user interface without affecting the operating logic having been assigned by a developer. Therefore, user interface creation system 10 may allow for rapid prototyping and updating of user interfaces for new version releases, manufacturer-specific customizations, OEMs, customizations for various market segments, etc.

As described above, user interface creation services 16 may intermediately define the user interface as declarative extensible markup language data, which is human and machine readable. In some embodiments, user interface creation services 16 may specify one or more user interface elements as managed objects associated with a code object to be instantiated upon parsing. In other words, unlike other markup languages where an element is merely a descriptor that will be connected to code, managed objects as declarative extensible markup language data allow for specification of a code object to be instantiated upon parsing. For example, a designer may create visible user interface elements as declarative extensible markup language data and then separate the user interface definition from the runtime logic by using code-behind files joined to the markup through partial class definitions. This general design principle may enable simplified code and debugging access for objects that are created as declarative extensible markup language data.

Further, the declarative extensible markup language data may be configured to provide portability and a consistent user experience across the Web, desktop and embedded devices. This may allow a user interface design and development team to reuse user interface elements across all three platforms, saving development time, strengthening branding, and reducing the learning curve for customers.

In some embodiments, the declarative extensible markup language data may be Extensible Application Markup Language (XAML) data configured to define user interface elements, data binding, and eventing. In such embodiments, XAML elements may map directly to common language runtime object instances, and XAML attributes may map to common language runtime properties and events on those objects. Unlike generic XML, XAML is targeted toward user interface element definition and behavior. As such, XAML can be used to simplify creating a user interface for a variety of different frameworks, including the Microsoft® .NET Framework programming model, as described by way of example below.

XAML has a set of rules that may map object elements into classes or structures, attributes into properties or events, and XML namespaces to common language runtime (CLR) namespaces. For example, XAML elements may map to .NET types as defined in referenced assemblies, and the attributes may map to members of those types. Properties in XAML may be set by setting properties on an object element, using a variety of possible syntaxes. Which syntaxes can be used for a given property will vary, based on the characteristics of the property being set. Further, within a project, the XAML may be written as a .xaml file, and a CLR language such as Microsoft® Visual Basic® .NET or C# may be used to write a code-behind file. As such, defining user interface elements as XAML data allows for separating the design phase from the development phase.

Continuing with FIG. 1, user interface creation system 10 may further include one or more web browsers, such as example web browser 24, configured to render the declarative extensible markup language data and visually present the user interface on a display device. Being able to display declarative extensible markup language data on a web browser may facilitate communication and collaboration amongst a user interface design team. For example, a geographically-distributed design team may be able to efficiently exchange virtual prototypes of a user interface, and view the prototypes in a web browser. As another example, viewing of the declarative extensible markup language data in a web browser environment may facilitate discussion of the user interface with regard to engineering, marketing, and sales.

Furthermore, such discussions may take place in parallel with the development phase of the user interface, since user interface creation system 10 allows for separation of the design phase from the development phase, as discussed above. In other words, such discussions may take place upon a design team's completion of a user interface and independent of a developer team's assignment of operation logic to the user interface.

API 14 further includes compiler services 26 for providing aspects of the declarative extensible markup language data to one or more compilers 28 for compilation into two or more different machine code implementations 30. Accordingly, each of the compilers 28 (i.e., compiling applications) may be configured to receive aspects of the declarative extensible markup language data from compiler services 26 of API 14. Compilers 28 may be further configured to compile the aspects of the declarative extensible markup language data into two or more different machine code implementations.

Each of the machine code implementations 30 may be natively executable without a virtual machine by a different hardware platform to present the user interface intermediately defined as declarative extensible markup language data. For example, example compiler 32 may generate example machine code implementation 34 natively executable on hardware platform 36, and example machine code implementation 38 natively executable on a different hardware platform 40. By eliminating the use of virtual machines, system resources of the device (e.g., embedded device) configured to run the user interface may utilize fewer system resources (e.g., less memory and/or fewer processing cycles). Further, because the interface is designed using robust tools available for designing interfaces for powerful computing systems, the different devices can have interfaces with the same rich features as more powerful computers, but with machine code that is efficient to execute. As an example, in some embodiments each machine code implementation may be natively executable without a virtual machine by a hardware platform of an embedded device.

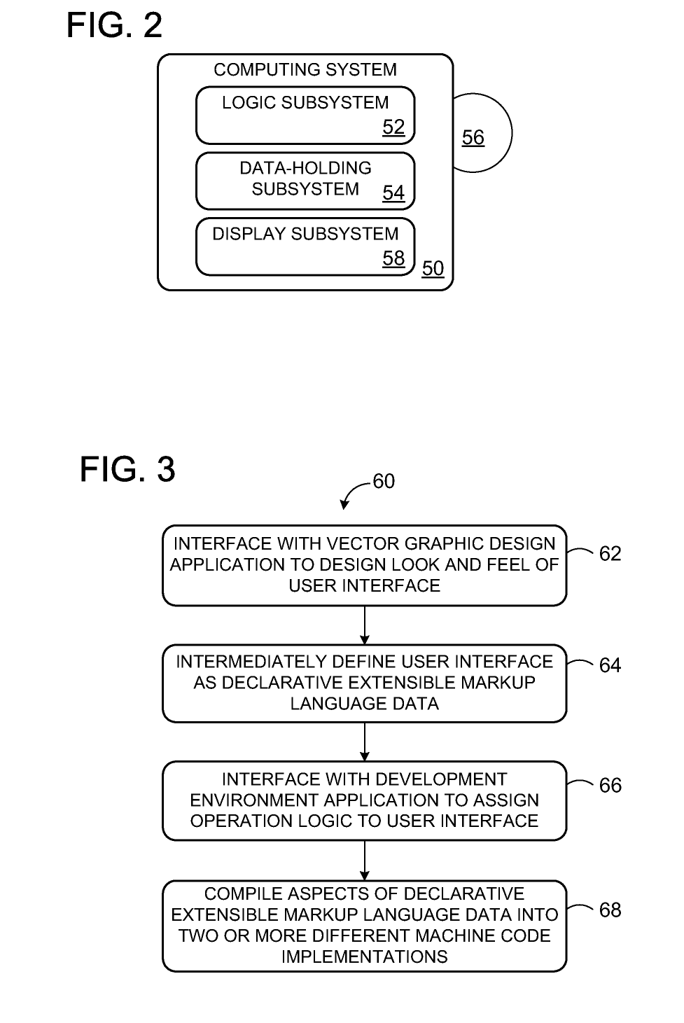

In some embodiments, one or more components of the above described user interface creation system may be tied to a computing system. As an example, FIG. 2 schematically shows a computing system 50 configured to run one or more of a vector graphic design application, a web browser, a development environment application, another functional component utilizing an API having user interface creation services, etc. Computing system 50 includes a logic subsystem 52 and a data-holding subsystem 54. Computing system 50 may optionally include a display subsystem and/or other components not shown in FIG. 2.

Logic subsystem 52 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 54 may include one or more physical devices configured to hold data and/or instructions executable by the logic subsystem to implement the herein described methods and processes. When such methods and processes are implemented, the state of data-holding subsystem 54 may be transformed (e.g., to hold different data). Data-holding subsystem 54 may include removable media and/or built-in devices. Data-holding subsystem 54 may include optical memory devices, semiconductor memory devices, and/or magnetic memory devices, among others. Data-holding subsystem 54 may include devices with one or more of the following characteristics: volatile, nonvolatile, dynamic, static, read/write, read-only, random access, sequential access, location addressable, file addressable, and content addressable. In some embodiments, logic subsystem 52 and data-holding subsystem 54 may be integrated into one or more common devices, such as an application specific integrated circuit or a system on a chip.

FIG. 2 also shows an aspect of the data-holding subsystem in the form of computer-readable removable media 56, which may be used to store and/or transfer data and/or instructions executable to implement the herein described methods and processes.

The terms “module” and “engine” may be used to describe an aspect of computing system 50 that is implemented to perform one or more particular functions. In some cases, such a module or engine may be instantiated via logic subsystem 52 executing instructions held by data-holding subsystem 54. It is to be understood that different modules and/or engines may be instantiated from the same application, code block, object, routine, and/or function. Likewise, the same module and/or engine may be instantiated by different applications, code blocks, objects, routines, and/or functions in some cases.

When included, display subsystem 58 may be used to present a visual representation of data held by data-holding subsystem 54. As the herein described methods and processes change the data held by the data-holding subsystem, and thus transform the state of the data-holding subsystem, the state of display subsystem 58 may likewise be transformed to visually represent changes in the underlying data. Display subsystem 58 may include one or more display devices utilizing virtually any type of technology. Such display devices may be combined with logic subsystem 52 and/or data-holding subsystem 54 in a shared enclosure, or such display devices may be peripheral display devices.

FIG. 3 shows a flow diagram of an example method 60 of user interface creation. Such a method may be utilized by a user interface creation system as described above. At 62, method 60 includes interfacing with a vector graphic design application to design a look and a feel of a user interface. At 64, method 60 includes intermediately defining the user interface as declarative extensible markup language data. At 66, method 60 includes interfacing with a development environment application to assign operation logic to the user interface. At 68, method 60 includes compiling aspects of declarative extensible markup language data into two or more different machine code implementations.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An application programming interface embodied on one or more data-holding subsystems, comprising:
user interface creation services for intermediately defining a user interface including one or more user interface elements as declarative extensible markup language data; and
compiler services for providing aspects of the declarative extensible markup language data to one or more compilers for compilation into two or more different machine code implementations, each machine code implementation natively executable without a virtual machine by a different hardware platform to present the user interface intermediately defined as the declarative extensible markup language data.

2. The application programming interface of claim 1, where each machine code implementation is natively executable without a virtual machine by a hardware platform of an embedded device.

3. The application programming interface of claim 2, where the declarative extensible markup language data is human and machine readable.

4. The application programming interface of claim 3, where the user interface creation services comprises vector graphic services compatible with a vector graphic design application having an interactive front-end visual editor environment for designing a look and a feel of the user interface independent of operation logic.

5. The application programming interface of claim 4, where the user interface creation services comprises logic assignment services for receiving from a development environment application one or more operation logic assignments corresponding to the user interface that are independent of the look and the feel of the user interface.

6. The application programming interface of claim 5, where the vector graphic services and the logic assignment services are independently operable.

7. The application programming interface of claim 3, where the user interface creation services is configured to specify one or more of the user interface elements as managed objects associated with a code object to be instantiated upon parsing.

8. The application programming interface of claim 2, where the declarative extensible markup language data is Extensible Application Markup Language (XAML) data configured to define user interface elements, data binding, and eventing, where XAML elements map directly to common language runtime object instances, and XAML attributes map to common language runtime properties and events on those common language runtime objects.

9. An application programming interface embodied on one or more data-holding subsystems, comprising:
user interface creation services comprising vector graphic services configured to interface with a vector graphic design application enabling visual design of a user interface including one or more user interface elements, and logic assignment services to interface with a development environment application enabling assignment of operation logic to the user interface, the user interface being intermediately defined as human and machine readable declarative extensible markup language data; and
compiler services for providing aspects of the declarative extensible markup language data to one or more compilers for compilation into two or more different machine code implementations, each machine code implementation natively executable without a virtual machine by a different hardware platform to present the user interface intermediately defined as the declarative extensible markup language data.

10. The application programming interface of claim 9, where each machine code implementation is natively executable without a virtual machine by a hardware platform of an embedded device.

11. The application programming interface of claim 10, where the vector graphic services is further configured to provide access to a web framework core of the vector graphic design application, the web framework core configured to integrate one or more of graphics, animations, multimedia and interactivity into a single runtime environment.

12. The application programming interface of claim 10, where the operation logic includes one or more of event handling, database manipulation, and business logic.

13. The application programming interface of claim 10, where the declarative extensible markup language data is Extensible Application Markup Language (XAML) data configured to define user interface elements, data binding, and eventing, where XAML elements map directly to common language runtime object instances, and XAML attributes map to common language runtime properties and events on those common language runtime objects.

14. A user interface creation system for creating a user interface, the user interface creation system comprising:
a vector graphic design application configured to enable visual design of the user interface including one or more user interface elements;
a development environment application configured to assign operation logic to the user interface;
an application programming interface embodied on one or more data-holding subsystems, the application programming interface comprising user interface creation services comprising vector graphic services configured to interface with the vector graphic design application and logic assignment services configured to interface with the development environment application, the user interface creation services intermediately defining the user interface as human and machine readable declarative extensible markup language data, the application programming interface further comprising compiler services; and
one or more compiling applications, each compiling application configured to receive aspects of the declarative extensible markup language data from the compiler services of the application programming interface, and to compile the aspects of the declarative extensible markup language data into two or more different machine code implementations, each machine code implementation natively executable without a virtual machine by a different hardware platform to present the user interface intermediately defined as the declarative extensible markup language data.

15. The user interface creation system of claim 14, where the user interface intermediately defined as the declarative extensible markup language data may be subsequently modified by the vector graphic design application independent of the development environment application.

16. The user interface creation system of claim 15, where the vector graphic design application comprises an interactive front-end visual editor environment for designing a look and a feel of the user interface independent of the operation logic.

17. The user interface creation system of claim 15, where the development environment application is configured to assign operation logic including one or more of event handling, database manipulation, and business logic, independent of the visual design of the user interface.

18. The user interface creation system of claim 14, further comprising a web browser configured to render the declarative extensible markup language data and visually present the user interface on a display device.

19. The user interface creation system of claim 14, where the declarative extensible markup language data is Extensible Application Markup Language (XAML) data configured to define user interface elements, data binding, and eventing, where XAML elements map directly to common language runtime object instances, and XAML attributes map to common language runtime properties and events on those common language runtime objects.

20. The user interface creation system of claim 14, where each machine code implementation is natively executable without a virtual machine by a hardware platform of an embedded device.
